(19) United States
(12) Patent Application Publication
(10) Pub. No.: US 2008/0106485 A1
(43) Pub. Date: May 8, 2008

(54) Portable electronic device and antenna thereof

(75) Inventors: Jiunn-Ming Huang, Taipei Hsien (TW); Chih-Lung Chen, Taipei Hsien (TW); Bang-Lin Liu, Taipei Hsien (TW); Pi-Hsi Cheng, Taipei Hsien (TW)

Correspondence Address: BACON & THOMAS, PLLC, 625 SLATERS LANE, FOURTH FLOOR, ALEXANDRIA, VA, 22314, US

(73) Assignee: WISTRON NEWEB CORP., Taipei Hsien (TW)

(21) Appl. No.: 11/806,287

(22) Filed: May 31, 2007

(30) Foreign Application Priority Data
Nov. 7, 2006 (TW) 095141199

(51) Int. Cl. H01Q 1/36

(52) U.S. Cl. 343/895

(57) ABSTRACT

A portable electronic device with function of receiving and radiating radio frequency (RF) signal and an antenna thereof are disclosed. The portable electronic device comprises an RF module and an antenna connecting to the RF module. The antenna comprises a helix element, a radiating element, and a base. The base comprises a ground element and a feeding portion that are separated from each other. The radiating element is disposed within the helix element. The radiating element is connected to the feeding portion, and the helix element is connected to the ground element.

### BACKGROUND OF THE INVENTION

1. Field of the Invention

The present invention relates to a portable electronic device and an antenna thereof, and more particularly, to a multi-frequency antenna and a portable electronic device applied with the same.

2. Description of the Related Art

With the evolution of wireless communication technology, various portable devices are exploiting wireless communication technology for data transmission, thus causing the antenna design to evolve at a rapid rate. Nowadays, these portable communication devices are becoming lighter and smaller, and the antenna must also be reduced in size in order to be installed into these electronic devices.

In terms of antenna's exterior design, the lengthy external antenna which is designed to receive and transmit radio frequency has become shorter and has been internalized, and it makes the appearance of the devices more appealing. In terms of application aspect, antenna is able to take on different shapes and sizes, thus the antennas can be designed accordingly to comply with various electronic appliance standards and to cater for different system products. Therefore, antenna manufacturing has the characteristic of high variety with low volume. However, the basic objective of designing an antenna is to improve the quality of signal transmission and reception, thus this property should not be compromised from improving its exterior appearance, size or choice of material.

Nowadays, the helical antenna and the monopole antenna are used in the circuit separately, and its pitfall is that both the helical antenna and the monopole antenna can only have a single-band frequency respectively. Although US patent publication number 2006/0050009A1 (claiming priority of TW Appln No.: 093127158) has disclosed a method of combining the application of a helical antenna and a monopole antenna, this application have both antennas fed into a positive current, that is, both antennas are fed into the feeding point and are connected to the same signal wire. Although this method allows the antenna to possess the characteristic of multi-band, it has limited bandwidth because it is not grounded and is still remained in the single resonance mode.

### SUMMARY OF THE INVENTION

In order to cater for the aforementioned needs in the precedent technology, the present invention provides a portable electronic device with an antenna which can be used for the transmission and reception of radio frequency (RF) signals. The portable electronic devices can be devices such as notebook computers (laptops), personal digital assistants (PDAs), or cellular phones. The portable electronic device comprises an RF signal module and an antenna, wherein the antenna and the RF signal modules are electrically connected. For example, the antenna can be electrically connected to the RF signal module through a signal cable (RF signal cable).

The antenna comprises a helix element, a radiating element and a base. The base comprises a grounding portion and a feeding portion that are electronically separated. For example, a first dielectric element can be installed between the feeding portion and the grounding portion, and the first dielectric element can be formed by dielectric material comprising sponge, acrylic fiber, plastic, or ceramic. The radiating element connecting to the feeding portion is disposed within the helix element. The helix element is connected to the ground.

In one embodiment, the present invention comprises a signal wire passing through the feeding portion of the base and connecting to the radiating element.

In a preferred embodiment, the antenna of the present invention further comprises a second dielectric element, which is disposed between the helix element and the radiating element. The second dielectric element is used to separate the helix element and the radiating element and is used to stabilize their position. The second dielectric element is formed by low dielectric material comprising such as sponge, acrylic fiber, plastic, or ceramic.

Furthermore, the antenna of the present invention can further comprise a third dielectric element, which covers at least a portion of the helix element so as to form the most outer part of the antenna. The material of the third dielectric element can be formed by low dielectric material comprising sponge, acrylic fiber, plastic, or ceramic.

The helix element of the present invention can be designed into different shapes according to the different fields or bandwidths. For example, the helix element can be strip-shaped, or the cross sectional area can be circular, square, oval, triangular, polyhedron or other shapes alike. The length of the helix element is substantially around ¼ λ (wavelength) of low frequency such as 2.4 GHz, for example. The length is calculated by stretching the helix element and measuring it from the grounding portion to its end.

Similarly, the radiating element can also take on different shapes according to the different configuration; for example, the overall shape can substantially be a straight line, cone shape, strip shape, helix shape, or other shapes alike. When the radiating element is strip-shaped, the strip can also take on other forms such as a square, triangular, or an oval shape. The length of the radiating element is substantially around ¼ λ (wavelength) of high frequency such as 5 GHz, for example. The length of the radiating element is calculated by stretching the radiating element and measuring it from the feeding portion.

Furthermore, the present invention can further comprise a load element to enhance the effect of the antenna. The load element is located either on the end of the helix element or on the end of the radiating element.

Moreover, the helix element of the present invention is a parasitical part of the grounding portion. Using the resonance frequency (e.g. high frequency) of the parasitical radiating element to radiate helix element by coupling energy is able to generate another form of resonance frequency (e.g. low frequency). Therefore, the radiated mode can provide a wide frequency band for different system. Various frequencies can be generated through this kind of antenna to cover a wide range of bandwidths for the system requirements. This antenna of the present invention has high practical industrial value as it is simple to design and it also leads to low manufacturing cost.

### BRIEF DESCRIPTION OF THE DRAWINGS

FIG. 1 is a perspective diagram showing an antenna for one of embodiments of the present invention.

FIG. 1A is a VSWR diagram for the embodiment in accordance with FIG. 1.

FIG. 1B is a diagram showing the average gains in the x-y plane in accordance with FIG. 1.

FIG. 1C is an efficiency diagram in accordance with FIG. 1.

FIG. 2 is a perspective diagram showing an antenna for one of embodiments of the present invention.

FIG. 2A is a diagram showing a signal wire connecting to a RF signal module in accordance with the embodiment in FIG. 2.

FIGS. 3A-5B are perspective diagrams showing different configurations of a second dielectric element and a third dielectric element for different embodiments in accordance with FIG. 1.

FIG. 6 is a perspective diagram showing an antenna of another embodiment in accordance with the present invention.

FIG. 7 is a 3-D diagram showing an antenna in different embodiments in accordance with the present invention.

FIG. 7A is a diagram showing the measurements of return loss in accordance with the embodiment in FIG. 7.

FIGS. 8-12 are perspective diagrams showing different antenna embodiments in accordance with the present invention.

FIGS. 13A-13C illustrate diagrams showing portable electronic devices, which also include antennas respectively in accordance with the present invention.

### DETAILED DESCRIPTION OF THE PREFERRED EMBODIMENT

The advantages and innovative features of the invention will become more apparent from the following detailed description when taken in conjunction with the accompanying drawings.

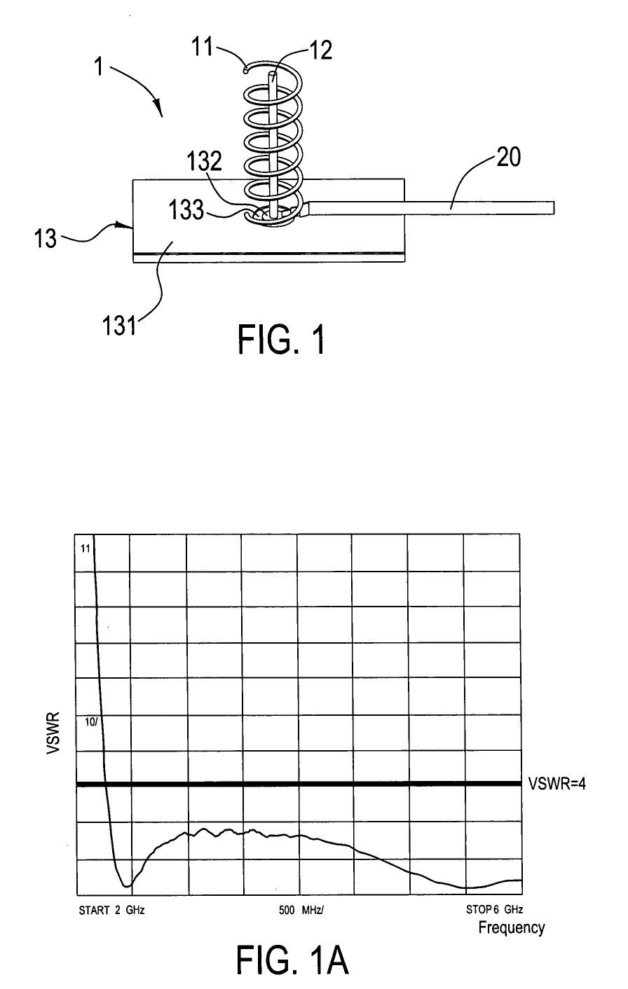

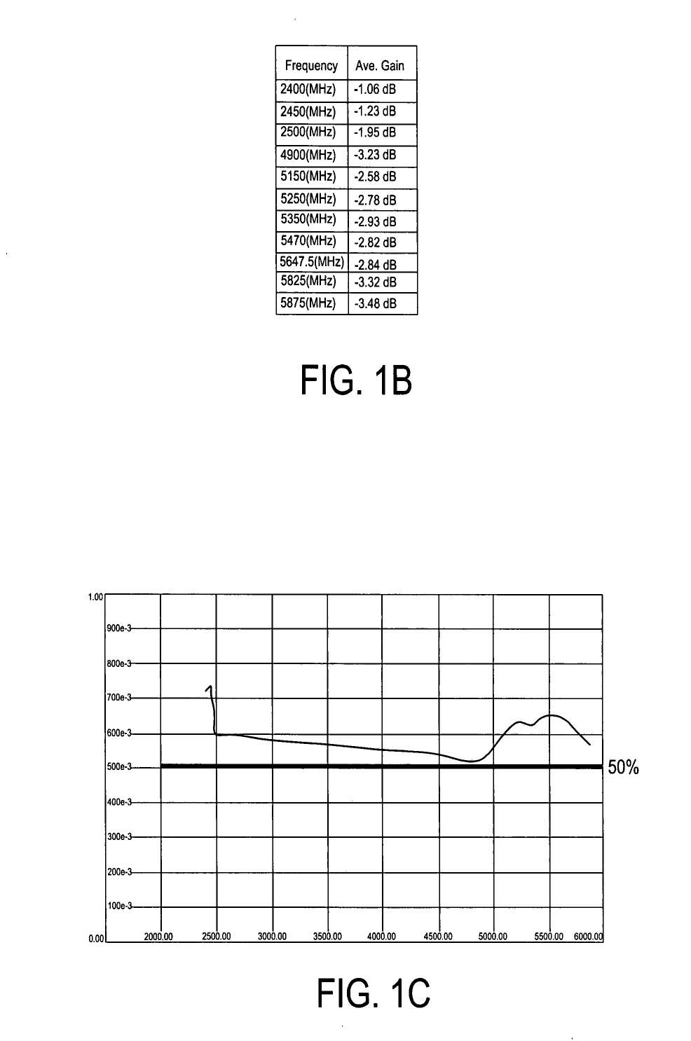

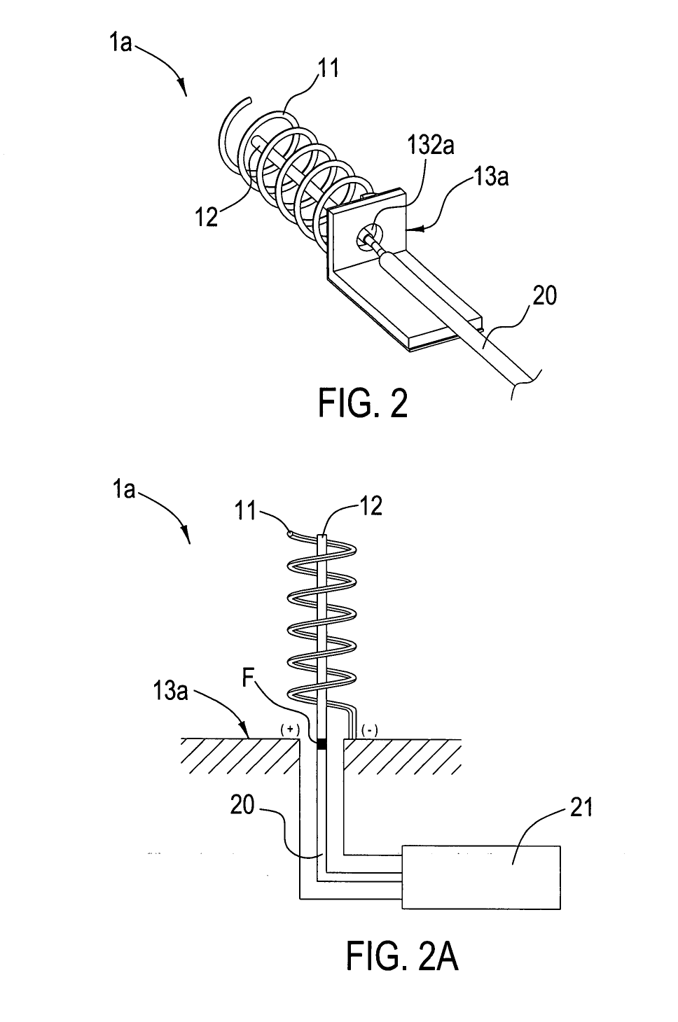

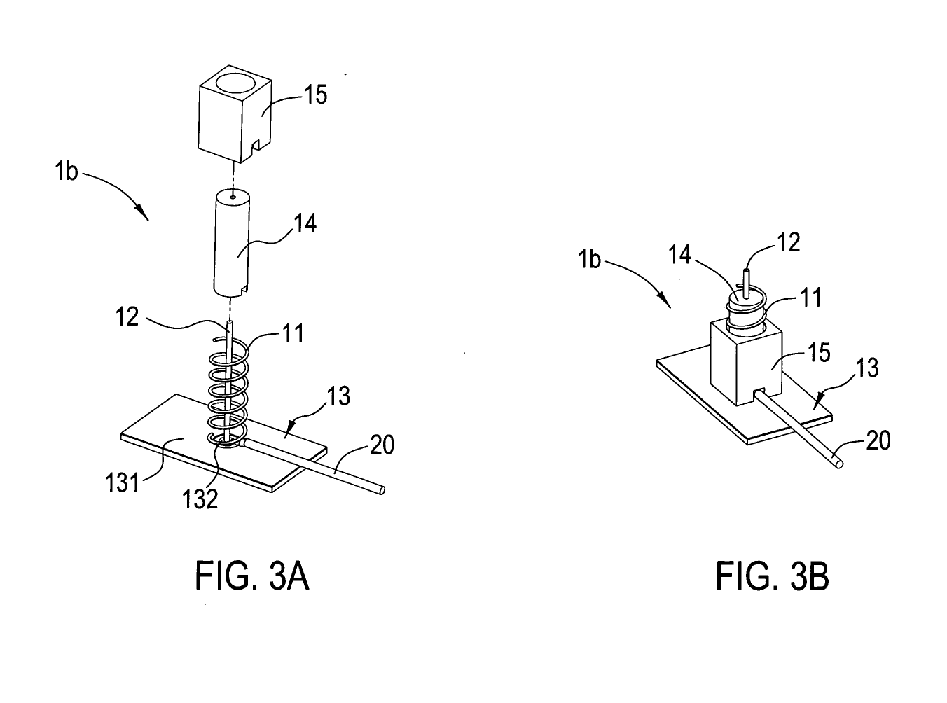

Refer to FIG. 1. An antenna 1 according to the present invention comprises a helix element 11, a radiating element 12, and a base 13. The base 13 comprises a ground element 131 and a feeding portion 132, wherein the grounding portion 131 and the feeding portion 132 are separated with each other. For example, the base 13 can be a multi-layered electronic circuit board, so the grounding portion 131 and the feeding portion 132 can be separated via applying electric connection to the different layers.

Alternatively, in another embodiment, the base 13 need not be a multi-layered circuit board. A first dielectric element 133 can be disposed between the feeding portion 132 and the grounding portion 131. The first dielectric element 133 is formed by the low dielectric material comprising, for example, sponge, acrylic fiber, plastic, or ceramic, such that the feeding portion 132 and the grounding portion 131 are electrically separated.

The radiating element 12 is connected to the feeding portion 132, and is disposed within the helix element 11. The helix element 11 is connected to the grounding portion 131. For example, the radiating element 12 may generate a high resonance frequency (e.g. 5 GHz) and the helix element 11 may generate a low resonance frequency (e.g. 2.4 GHz).

FIG. 1A is a Voltage Standing Wave Ratio (VSWR) diagram for the embodiment in accordance with FIG. 1. As shown in FIG. 1A, it is apparent that the outstanding VSWR can be obtained under both high and low frequencies.

Refer to FIG 1B, which is a diagram showing the average gain in the x-y plane for the embodiment in accordance with FIG. 1. As can be seen from FIG. 1B, the average gain in the frequency region of 2.4 GHz is greater than −2.0 dB, which is much higher than the industry requirement's −4.0 dB; the average gain in the frequency region of 5.0 GHz is greater than −3.5 dB, which is higher than the industry requirement's −5.0 dB. Furthermore, it is apparent that the efficiency is above 50% as shown in the efficiency diagram FIG. 1C.

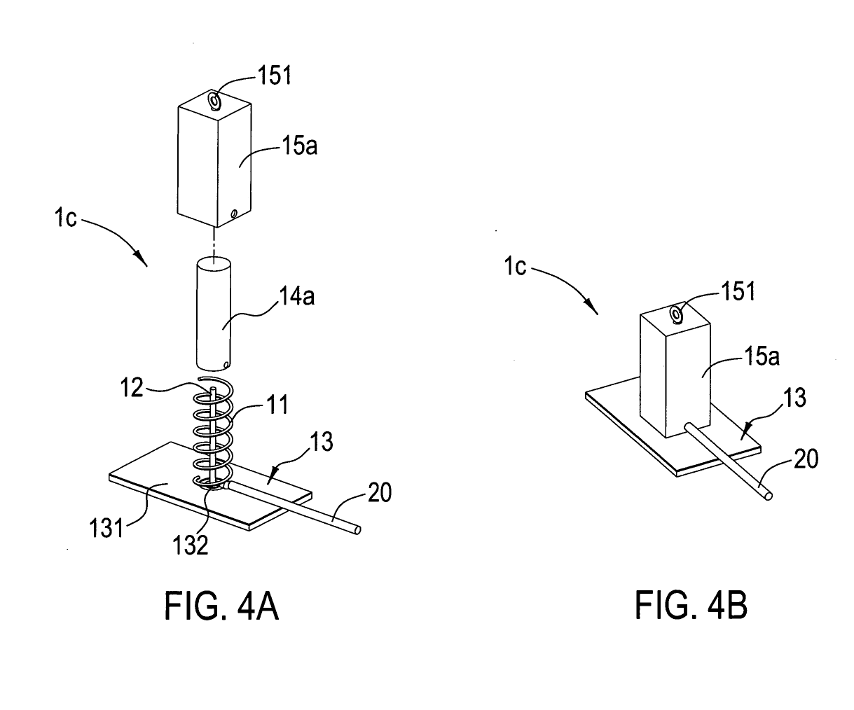

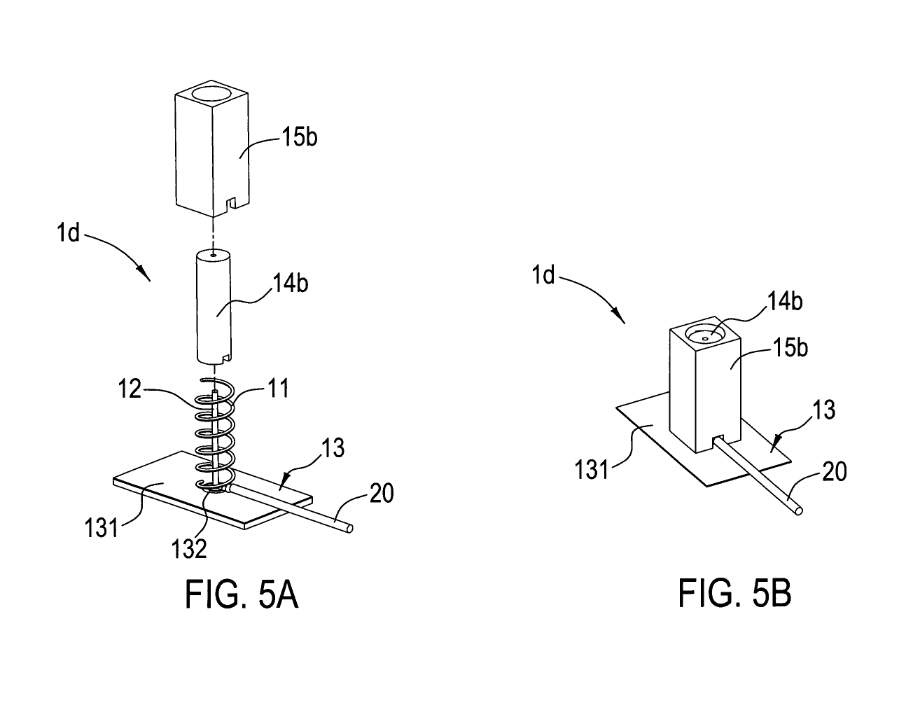

Refer to FIG. 2 and FIG. 2A at the same time. An antenna 1a may further comprise a signal wire 20, and the signal wire 20 can be connected to a RF signal module 21, such as a WLAN module. The RF signal module 21 can be used to process RF signals received or transmitted by the antenna 1a. In the present embodiment, the signal wire 20 passes through the feeding portion 132a of the base 13a and connects to the radiating element 12, so that the joint feeding point F of the radiating element 12 and of the signal wire 20 is located at the feeding portion 132a. In other words, the helix element 11 is connected to the ground (negative), and the radiating element 12 is connected to the signal wire 20 (positive). In the present embodiment, the helix element 11 can be connected to the base 13a to form the ground. As an example, the base 13a can be made of metals to reduce the cost of the antenna 1a.

Furthermore, the base 13 or 13a can be folded into various shapes to comply with other physical devices that it is to be installed (for example a laptop). Alternatively, the antenna 1 or 1a can simply be glued onto other devices by applying adhesives to the surface of the base 13 or 13a.

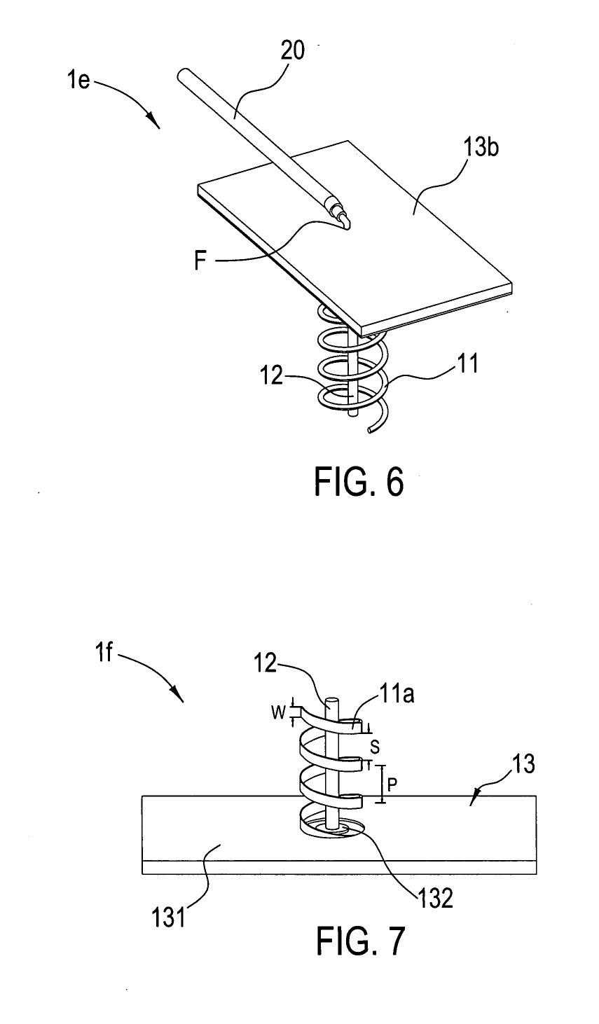

Refer to FIG. 3A for one preferred embodiment. The antenna 1b of the present invention may further comprise a second dielectric element 14 disposed between the helix element 11 and the radiating element 12. The second dielectric element 14 separates and secures the position of the helix element 11 and the radiating element 12, wherein the material of the second dielectric element 14 is formed by low dielectric material such as sponge, acrylic fiber, plastic, ceramic, or the like.

Moreover, the antenna 1b may further comprise a third dielectric element 15, and the third dielectric element 15 disposed at the outer of antenna 1b can cover at least a portion of the helix element 11. The third dielectric element 15 is formed by low dielectric material such as sponge, acrylic fiber, plastic, ceramic, or the like.

Refer to FIG. 4A, FIG. 4B, FIG. 5A and FIG. 5B simultaneously. The size of the second dielectric element 14a, 14b and the third dielectric element 15a, 15b can be modified according to different design requirements. For example, as shown in FIG. 4A and 4B, the third dielectric element 15a covers the helix element 11 completely. The antenna 1c may further comprise a securing element 151 or the like such that the antenna 1c can be screwed and assembled onto other devices.

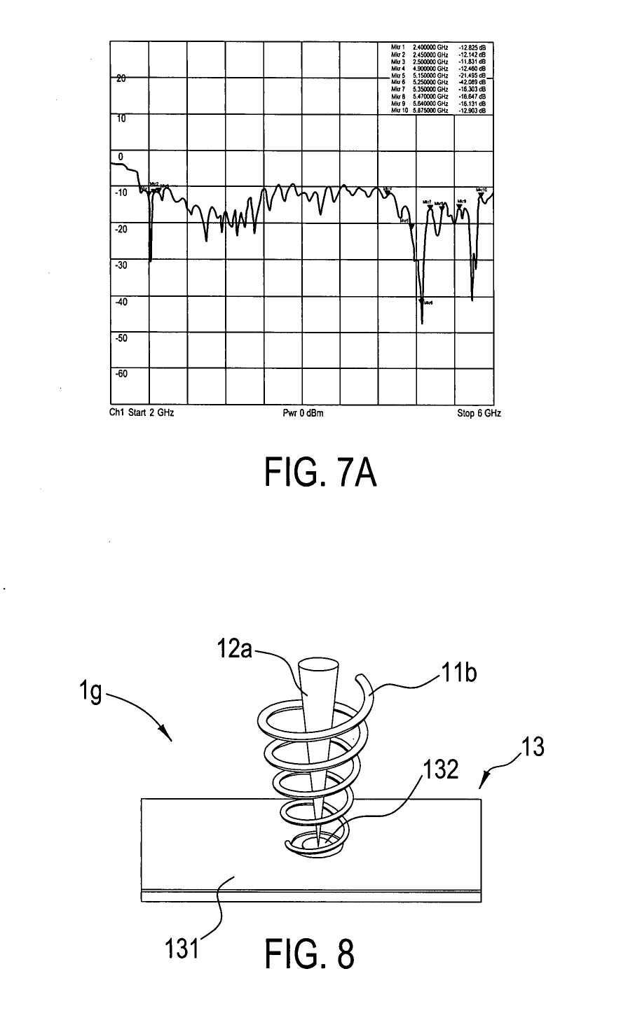

Referring to FIG. 6, the signal wire 20 connecting to the other side of the base 13b differs from that shown in FIG. 1. This embodiment shows, in different design of the base 13b, the feeding point F of the radiating element 12 can be located on the other side of the base 13b. These figures are to illustrate the different configurations of embodiments, and should not be used to limit the present invention.

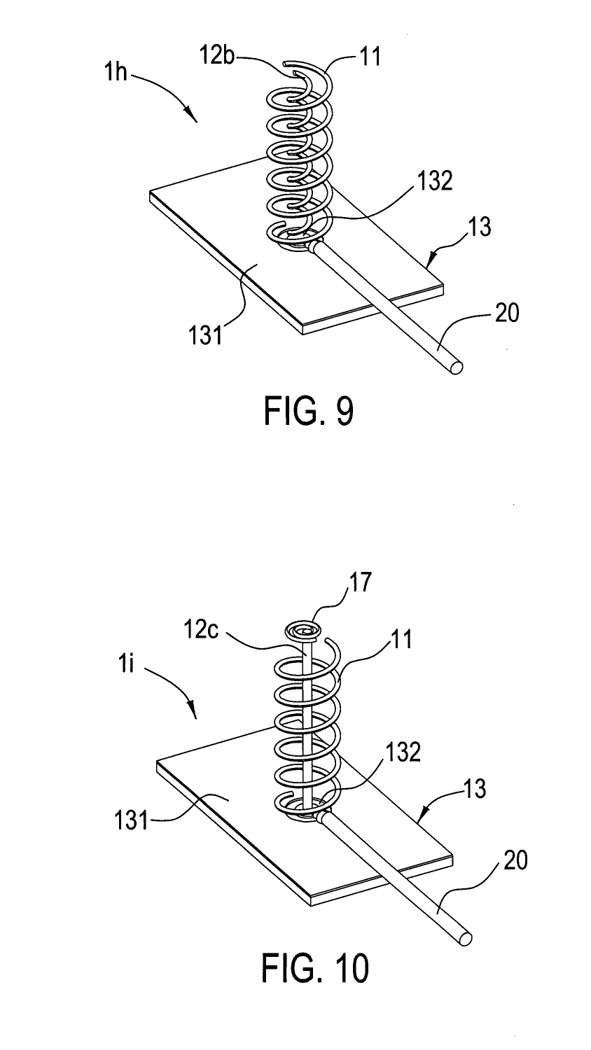

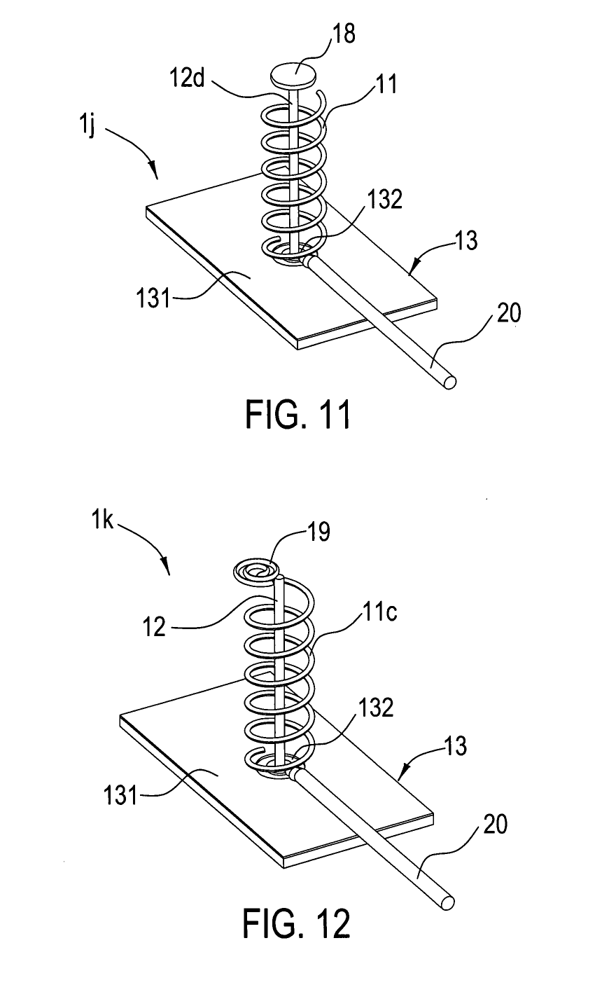

In one embodiment of the present invention, the helix element 11a can be strip-shaped as shown in FIG. 7. For example, the width W can be 3.85 mm, and the distance between the two helixes S can be 3.4 mm, and the distance between the middle points of two helixes P can be 7.25 mm.

FIG. 7A is a diagram showing the measurements of return loss in accordance with the embodiment in FIG. 7. As shown in FIG. 7A, it is apparent that the antenna 1f in FIG. 7 results in a very low return loss in the region of 2.4 GHz and 5 GHz, which means a low energy loss.

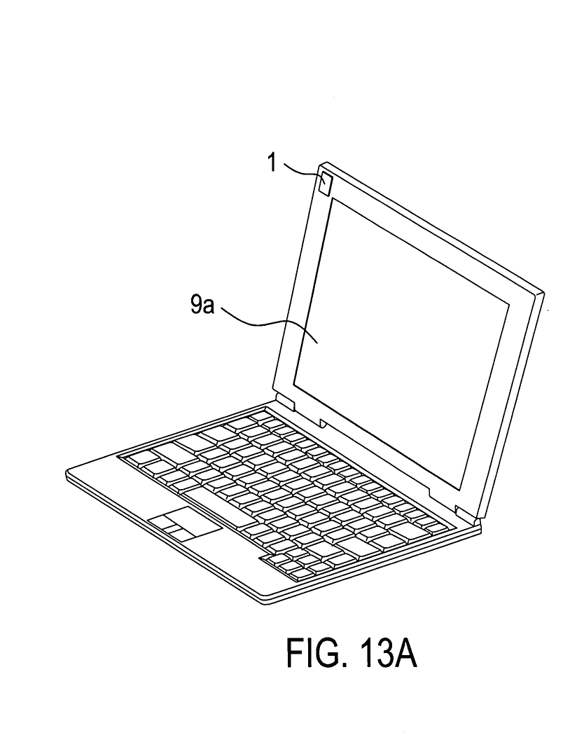

Furthermore, the helix element of the present invention can be strip-shaped as shown in FIG. 7, or the cross-sectional area of the helix can be circular, square, oval, triangular, polyhedron or other shapes alike (not shown in the figure) depending on the different fields or frequency requirements. Essentially, as long as the pillar object is in the shape of cylindrical, a cone, a rectangular, an oval, a triangular or a polyhedron, then a metal strip can be used to wind around the pillar object to construct the helix element into different shapes, so it will not be explained further. The length of the helix element is substantially around ¼ λ (wavelength) of low frequency such as 2.4 GHz for example. The length is calculated by stretching the helix element and measuring it from the grounding portion to its end. FIG. 8 shows another embodiment of the helix element 11b shaping as a cone.

Similarly, the radiating element can also take on different shapes according to different requirements, for example, the overall shape can substantially be a straight line (as shown in FIG. 1), a cone, a strip, a helix, or other shapes alike.

Refer to FIG. 9. When the radiating element 12b is helix-shaped, antenna 1h comprises two helix elements. When the radiating element 12b is strip-shaped, the strip can also take on other forms such as a square, triangular, or oval shape (not shown in the figure). The length of the helix element is substantially around ¼ λ (wavelength) of high frequency such as 5 GHz, for example. The length is calculated by stretching the helix element and measuring it from the grounding portion to its end.

Refer to FIG. 10 to FIG. 12, the antenna 1i, 1j, or 1k of the present invention can further comprise an load element 17, 18 or 19 to enhance the effect of the antennas. As shown in FIG. 10 and FIG. 11, the load element 17 and 18 can be disposed on the radiating element 17 and 18 respectively, and the load element 17 and 18 can be designed in various shapes. Alternatively, as shown in FIG. 12, the load element 19 can be disposed at the helix element 11c. In other words, in order to radiate energy more effectively, the load element 17, 18 and 19 can be disposed at the helix element 11c or on the either ends of the radiating elements 12c or 12d.

In summary, the helix element of the present invention is a parasitical part of the grounding portion. Using the resonance frequency (e.g. high frequency) of the parasitical radiating element to radiate helix element by coupling energy is able to generate another form of resonance frequency (e.g. low frequency). Therefore, the radiated mode can provide a wide frequency band for different system. Various frequencies can be generated through this kind of antenna to cover a wide range of bandwidths for the system requirements. The antenna of the present invention has high practical industrial value as it is simple to design and it also leads to low manufacturing cost.

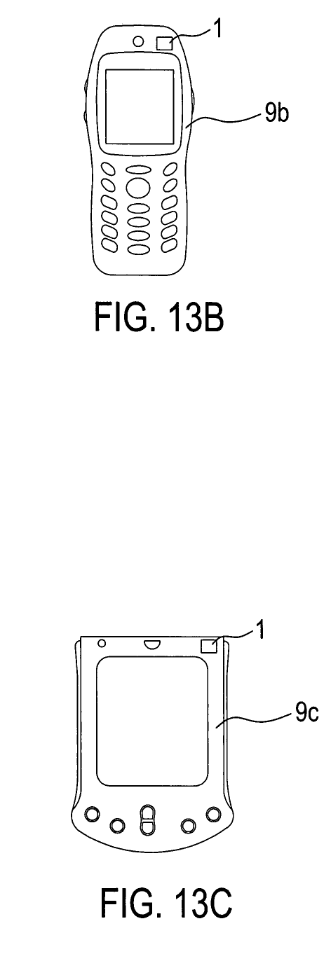

Refer to FIG. 13A to FIG. 13C. A portable electronic device can be one of the devices such as a notebook computer (laptop) 9a, a personal digital assistant (PDA) 9c, or a cellular phone 9b. The portable electronic device comprises a RF signal module (such as the RF signal module 21 shown in FIG. 2A) and an antenna (as described above any one of the antenna1, 1a-k).

In order to simplify the discussion, the antenna 1 will be used to represent other antennas for below description. The antenna 1 and the RF signal modules 20 can be electrically connected through the signal wire 20 (such as a RF cable). Each portable electronic device 9a, 9b or 9c carries an antenna 1, thus transmission and reception of wireless signals can be performed through the antenna 1. The antenna 1 does not have to be implemented at the position as shown in FIG. 13A to FIG. 13C, it can be implemented in accordance with the different design requirements of the portable electronic device 9a, 9b or 9c.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An antenna comprising:
a base comprising a grounding portion and a feeding portion that are electrically separated;
a helix element connecting to the ground; and
a radiating element connecting with the feeding portion within the helix element.

2. The antenna as claimed in claim 1, wherein the radiating element is in the form of a straight line, a cone, a strip, or a spiral.

3. The antenna as claimed in claim 1, which further comprises a first dielectric element disposed between the feeding portion and the ground element.

4. The antenna as claimed in claim 3, wherein the first dielectric element is formed by dielectric material comprising sponge, acrylic fiber, plastic, or ceramic.

5. The antenna as claimed in claim 1, which further comprises a signal wire passing through the feeding portion of the base and connecting with the radiating element.

6. The antenna as claimed in claim 1, which further comprises a second dielectric element disposed between the helix element and the radiating element.

7. The antenna as claimed in claim 6, wherein the second dielectric element is formed by dielectric material comprising sponge, acrylic fibers, plastic, or ceramic.

8. The antenna as claimed in claim 1, which further comprises a third dielectric element covering at least a portion of the helix element.

9. The antenna as claimed in claim 8, wherein third dielectric is formed by dielectric material comprising sponge, acrylic fiber, plastic, or ceramic.

10. The antenna as claimed in claim 1, wherein the helix element is a strip-shaped helix wire.

11. The antenna as claimed in claim 1, wherein the cross-section of the helix element is circular, square, oval, triangular, or polyhedron.

12. The antenna as claimed in claim 1, which further comprises a load element disposed at one end of the radiating element.

13. The antenna as claimed in claim 1, which further comprises a load element disposed at one end of the helix element.

14. A portable electronic device comprising:
A RF signal module;
An antenna electrically coupled with the RF signal module, the antenna comprising:
a base comprising a grounding portion and a feeding portion that are electrically separated;
a helix element connecting with the grounding portion; and
a radiating element connecting with the feeding portion within the helix element.

15. The portable electronic device as claimed in claim 14, wherein the portable electronic device can be a notebook computer (laptop), a personal digital assistant (PDA), or a cellular phone.

16. The portable electronic device as claimed in claim 14, wherein the radiating element of the antenna is in the form of a straight line, a cone, a strip, or a spiral.

17. The portable electronic device as claimed in claim 14, wherein the antenna further comprises a first dielectric element disposed between the feeding portion and the ground element.

18. The portable electronic device as claimed in claim 17, wherein the first dielectric element is formed by dielectric material comprising sponge, acrylic fiber, plastic, or ceramic.

19. The portable electronic device as claimed in claim 14, wherein the antenna further comprises a signal wire passing through the feeding portion of the base and connecting with the radiating element.

20. The portable electronic device as claimed in claim 14, wherein the antenna further comprises a second dielectric element disposed between the helix element and the radiating element.

21. The portable electronic device as claimed in claim 20, wherein the second dielectric element is formed by dielectric material comprising sponge, acrylic fiber, plastic, or ceramic.

22. The portable electronic device as claimed in claim 14, wherein the antenna further comprises a third dielectric element covering at least a portion of the helix element.

23. The portable electronic device as claimed in claim 22, wherein the third dielectric is formed by dielectric material comprising sponge, acrylic fiber, plastic, or ceramic.

24. The portable electronic device as claimed in claim 14, wherein the helix element is a strip shaped helix wire.

25. The portable electronic device as claimed in claim 14, wherein the cross-section of the helix element is circular, square, oval, triangular, or polyhedron.

26. The portable electronic device as claimed in claim 14, wherein the antenna further comprises a load element disposed at one end of the radiating element.

27. The portable electronic device as claimed in claim 14, wherein the antenna further comprises a load element disposed at one end of the helix element.
